(19) United States
(12) Patent Application Publication
(10) Pub. No.: US 2014/0232699 A1
(43) Pub. Date: Aug. 21, 2014

(54) Interactive Projection System with Actuated Stylus

(71) Applicant: MICROVISION, INC., Redmond, WA (US)

(72) Inventors: P. Selvan Viswanathan, Bellevue, WA (US); Roeland Collet, Olympia, WA (US)

(73) Assignee: Microvision, Inc., Redmond, WA (US)

(21) Appl. No.: 13/772,153

(22) Filed: Feb. 20, 2013

(51) Int. Cl. G06F 3/0354

(52) U.S. Cl. CPC G06F 3/03545
USPC 345/179

(57) ABSTRACT

An actuated stylus conditionally occludes or exposes a reflector. The actuation mechanism may be mechanical, electrical, or a combination. When the reflector is occluded and the stylus is in the field of view of an interactive projection, no light is reflected back to the projection system. When the reflector is exposed, light is reflected back to the projection system. The reflector may be exposed in a time coded sequence to encode information such as a stylus ID and user action.

### FIELD

The present invention relates generally to scanning laser projectors, and more specifically to interactive scanning laser projection displays.

### BACKGROUND

Projection systems typically project a visible image on a surface. For example, a projection system may project the contents of a computer display on a wall. Some projection systems include a camera and image processing circuits to allow a user to interact with projected content. The image processing circuits compare the projected content to an image captured by the camera to determine the extent of user interaction.

### BRIEF DESCRIPTION OF THE DRAWINGS

FIG. 1 shows an interactive projection system with an actuated stylus in accordance with various embodiments of the present invention;

FIG. 2A shows a cross section of a mechanically actuated stylus with an occluded reflector in accordance with various embodiments of the present invention;

FIG. 2B shows a cross section of the stylus of FIG. 2A with an exposed reflector in accordance with various embodiments of the present invention;

FIG. 3 shows a cross section of a stylus with a mechanical actuating mechanism in accordance with various embodiments of the present invention;

FIG. 4 shows a cross section of a stylus with a spring loaded mechanical actuating mechanism in accordance with various embodiments of the present invention;

FIG. 5 shows a cross section of a stylus with a rotating mechanical actuating mechanism in accordance with various embodiments of the present invention;

FIG. 6A shows an electrically actuated stylus with an occluded reflector in accordance with various embodiments of the present invention;

FIG. 6B shows the stylus of FIG. 6A with an exposed reflector in accordance with various embodiments of the present invention;

FIGS. 7 and 8 show block diagrams of electrically actuated styluses in accordance with various embodiments of the present invention;

FIG. 9 shows a coded sequence in accordance with various embodiments of the present invention;

FIG. 10 shows an interactive projection system with multiple actuated styluses in accordance with various embodiments of the present invention;

FIG. 11A shows a cross section of an actuated stylus with an occluded photodetector and radio frequency transmitter in accordance with various embodiments of the present invention;

FIG. 11B shows a cross section of the stylus of FIG. 11A with an exposed photodetector in accordance with various embodiments of the present invention;

FIG. 12 shows a block diagram of an actuated stylus with a photodetector and radio frequency transmitter in accordance with various embodiments of the present invention;

FIG. 13A shows an actuated stylus with an occluded photodetector and radio frequency transmitter in accordance with various embodiments of the present invention;

FIG. 13B shows the stylus of FIG. 13A with an exposed photodetector in accordance with various embodiments of the present invention;

FIG. 14 shows a block diagram of an actuated stylus with a photodetector and radio frequency transmitter in accordance with various embodiments of the present invention; and

FIG. 15 shows a flow diagram of methods in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

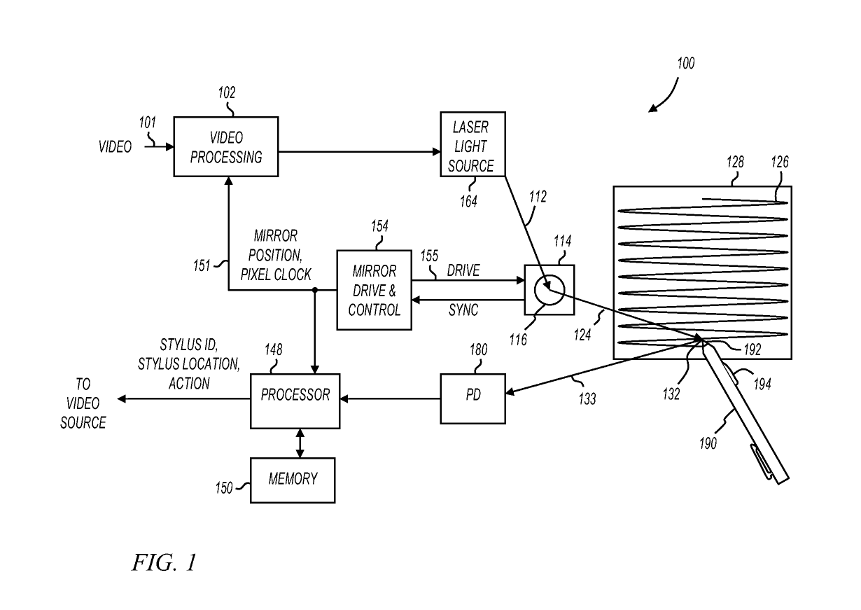

FIG. 1 shows an interactive projection system with an actuated stylus in accordance with various embodiments of the present invention. As shown in FIG. 1, system 100 includes a scanning laser projection apparatus and a stylus 190. The scanning laser projection apparatus includes video processing component 102, laser light source 164, mirror drive and control circuits 154, scanning platform 114, photodetector 180, processor 148, and memory 150.

In operation, video processing component 102 receives video data from a video source (not shown) on node 101 and produces display pixel data representing luminance values of pixels that are to be displayed. The video data 101 represents image source data that is typically received from a host device with pixel data on a rectilinear grid, but this is not essential. For example, video data 101 may represent a grid of pixels at any resolution (e.g., 640×480, 848×480, 1280×720, 1920×1080). The raster pattern produced by system 100 does not necessarily align with the rectilinear grid in the image source data, and video processing component 102 operates to produce display pixel data that will be displayed at appropriate points on the raster pattern. For example, in some embodiments, video processing component 102 interpolates vertically and/or horizontally between pixels in the source image data to determine display pixel values along the scan trajectory of the raster pattern.

Video processing component 102 may include any circuitry capable of performing the functions described. For example, in some embodiments, video processing component 102 includes digital circuits capable of performing interpolation such as multipliers, shifters, and adders. Also for example, in some embodiments, video processing component 102 may include hardware circuits and may also include a processor that executes instructions.

Light source 164 receives commanded luminance values from video processing component 102 and produces modulated light beam 112 having grayscale values in response to the commanded luminance values. Light source 164 may be monochrome or may include multiple different color light sources. For example, in some embodiments, light source 164 includes red, green, and blue light sources. In these embodiments, video processing component 102 outputs display pixel luminance values corresponding to each of the red, green, and blue light sources. Also for example, light produced by light source 164 may be visible or nonvisible. For example, in some embodiments, one or more sources of light within light source 164 may produce infrared (IR) light.

Light beam 112 impinges on scanning platform 114 which is part of a microelectromechanical system (MEMS) based scanner or the like. In some embodiments, additional optical elements are included in the light path between light source 164 and scanning platform 114. For example, some embodiments may include collimating lenses, dichroic mirrors, or any other suitable optical elements. Light beam 112 then reflects off scanning mirror 116 to generate a controlled output beam 124. A scanning mirror drive and control circuit 154 provides one or more drive signal(s) to control the angular motion of scanning mirror 116 to cause output beam 124 to generate a raster scan 126 of pixels on a projection surface 128. In operation, light source 164 is modulated to produce light pulses, and scanning mirror 116 reflects the light pulses to create display pixels as beam 124 traverses raster pattern 126.

Scanning mirror 116 deflects on two axes in response to drive stimuli received on node 155 from mirror drive and control circuits 154. The shape of the raster pattern swept by scanning mirror 116 is a function of the mirror movement on its two axes. For example, in some embodiments, scanning mirror 116 sweeps in a first dimension (e.g., vertical dimension) in response to sawtooth wave stimulus, resulting in a substantially linear and unidirectional vertical sweep. Also for example, in some embodiments, scanning mirror 116 sweeps in a second dimension (e.g., horizontal dimension) according to a sinusoidal stimulus, resulting in a substantially sinusoidal horizontal sweep.

Scanning platform 114 is an example of a scanning mirror assembly that scans light in two dimensions. In some embodiments the scanning mirror assembly includes a single mirror that scans in two dimensions (e.g., on two axes). Alternatively, in some embodiments, scanning platform 114 may be an assembly that includes two scan mirrors, one which deflects the beam along one axis, and another which deflects the beam along a second axis largely perpendicular to the first axis.

Photodetector 180 is shown receiving a reflection from a reflector 192 on stylus 190 within the field of view of the projection apparatus. Reflector 192 may incorporate any type of reflective device or material that can reflect all or a portion of output beam 124. For example, in some embodiments, reflector 192 may be a corner reflector or a retroreflector. Also for example, in other embodiments, reflector 192 may include reflective tape with diffusive qualities.

In various embodiments of the present invention, stylus 190 includes an actuating mechanism configured to conditionally expose or occlude reflector 192. For example, in some embodiments, button 194 may be part of a mechanical actuating mechanism that when actuated causes reflector 192 to be exposed. In other embodiments, button 194 may be part of a mechanical actuating mechanism that when actuated causes reflector 192 to be occluded. Various embodiments provide for mechanical exposure and/or occlusion of reflector 192 using different mechanisms. For example, in some embodiments, reflector 192 is at rest occluded within the body of stylus 190 and protrudes out from the end of stylus 190 to become exposed in response to a press of button 194. In other embodiments, reflector 192 is at rest exposed outside stylus 190, and withdraws into the body of stylus 190 in response to a press of button 194. In still further embodiments, reflector 192 is stationary, and a cover conditionally exposes or occludes the reflector in response to a press of button 194.

In some embodiments, the actuating mechanism includes electrical components or a combination of electrical and mechanical components. For example, reflector 192 may be occluded by a liquid crystal element. In response to a press of button 194, a voltage may be applied to the liquid crystal element, thereby exposing reflector 192. In still further embodiments, a liquid crystal element may occlude reflector 192 in response to a press of button 194.

In some embodiments, the actuating mechanism exposes or occludes reflector 192 in a coded time sequence. For example, stylus 190 may expose reflector 192 as a time sequence of exposures for a single press of button 194. Any information may be encoded. For example, a coded time sequence may encode a button press, a stylus identifier, or the like. The time sequence of exposures may include exposures of different time durations as well exposures with different spacings in time.

In some embodiments, reflector 192 is replaced by a photodetector, and stylus 190 includes a radio frequency circuit. In these embodiments, when the actuating mechanism exposes the photodetector, the radio frequency circuit transmits a signal back to the scanning laser projector.

When controlled output beam 124 passes over reflector 192, light is reflected as shown at 133. The reflected light is sensed by photodetector (PD) 180. As described more fully below, the timing of the reflected light can be compared to the timing of the raster scan 126 to determine the location of the reflector 192 relative to the image painted by raster scan 126. For example, when a particular pixel 132 is reflected by reflector 192, determining the location of that pixel within the raster scan 126 also determines the location of the reflector within the raster scan 126.

In some embodiments, light source 164 sources nonvisible light such as infrared light. In these embodiments, PD 180 is able to detect the same wavelength of nonvisible light. For example, in some embodiments, light source 164 may be an infrared laser diode that produces light with a wavelength of substantially 808 nanometers (nm). The wavelength of light is not a limitation of the present invention. Any wavelength, visible or nonvisible, may be used without departing from the scope of the present invention.

In some embodiments, mirror drive and control circuit 154 has knowledge of the position of scanning mirror 116, from which the position of reflected pixel 132 may be derived. For example, mirror drive and control circuits 154 may receive one or more sync signals from scanning platform 114 describing horizontal and vertical mirror positional information. Mirror drive and control circuits 154 may output the mirror position information at 151. Mirror drive and control circuits 154 may also generate and distribute a pixel clock at 151. Various other circuits receive the mirror position information and pixel clock. For example, video processing component 102 may utilize the mirror position information and pixel clock to determine what image pixel information is to be used to generate display pixel information and when. Also for example, processor 148 may use the mirror position information to determine the location of reflector 192 within raster scan 126.

As shown in FIG. 1, processor 148 provides the stylus ID, location, and action to the source of the video data on node 101. In some embodiments, the video source is a host device such as a mobile phone or tablet computer. In other embodiments, the video source is an application program running on a separate processor. The application program may use the information provided by the interactive projection system to interact with the user in possession of stylus 190.

Processor 148 is configured to receive an indication of reflected light from photodetector 180 and determine an x,y location of the reflector within the display field. In some embodiments, memory 150 holds instructions that when executed by processor 148 cause processor 148 to determine the stylus location, and to recognize a sequence of reflections as having emanated from a stylus. For example processor 148 may determine a coded stylus ID and an action (e.g., button click). In some embodiments, processor 148 and memory 150 are replaced by one or more application specific integrated circuits that are configured to perform the same function.

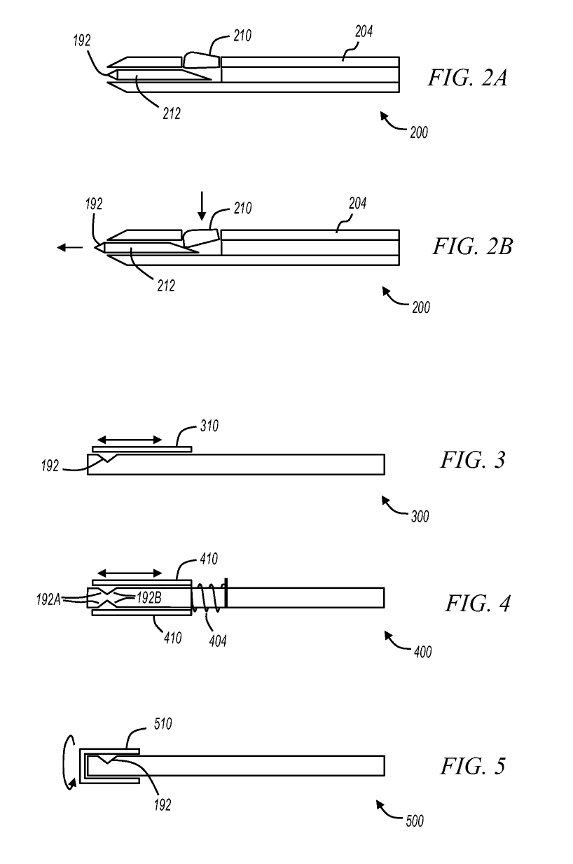

FIG. 2A shows a cross section of a mechanically actuated stylus with an occluded reflector in accordance with various embodiments of the present invention. Stylus 200 may be used as a mechanically actuated stylus in an interactive projection system. For example, stylus 200 may be used as stylus 190 (FIG. 1). Stylus 200 includes button 210 and rod 212 with reflector 192. In some embodiments, reflector 192 is positioned near the tip of rod 212 as shown in FIG. 1. When button 210 is not depressed as shown in FIG. 2A, rod 212 is at rest within the body 204 of stylus 200, and reflector 192 is occluded. If stylus 200 is held within the field of view of a projector as shown in FIG. 1, no pixel reflection will be returned to the projection system because reflector 192 is occluded.

FIG. 2B shows a cross section of the stylus of FIG. 2A with an exposed reflector in accordance with various embodiments of the present invention. FIG. 2B shows button 210 depressed, which forces the tip of rod 212 and reflector 192 to become exposed. If stylus 200 is in the field of view of a projection system when reflector 192 is exposed as in FIG. 2B, reflections may be returned to the projection system.

FIGS. 2A and 2B show a mechanically actuated stylus that has an occluded reflector when at rest, and has an exposed reflector when actuated. Some embodiments include a mechanically actuating mechanism that exposes a reflector when at rest and occludes the reflector when actuated. Further, stylus 200 is shown greatly simplified. One skilled in the art will understand that stylus 200 may include many parts not shown in FIGS. 2A and 2B.

FIG. 3 shows a cross section of a stylus with a mechanical actuating mechanism in accordance with various embodiments of the present invention. Stylus 300 may be used as a mechanically actuated stylus in an interactive projection system. For example, stylus 300 may be used as stylus 190 (FIG. 1). Stylus 300 includes reflector 192 and actuating mechanism 310. In operation, actuating mechanism 310 translates along the body of the stylus to expose reflector 192 when actuated. Actuating mechanism 310 represents any mechanical actuating mechanism that slides or translates along the body of the stylus to expose or occlude reflector 192. In some embodiments, actuating mechanism 310 is positioned on stylus 300 in such a manner that a user's finger or thumb can easily operate the mechanism to expose reflector 192. Although reflector 192 is shown only on one side of the tip of stylus 300, this is not a limitation of the present invention. For example, in some embodiments, reflector 192 is positioned around the circumference of the stylus so as to simplify or reduce any stylus orientation requirements when positioning the stylus within the projection system's field of view.

In some embodiments, one or more slots (not shown) in actuating mechanism 310 expose reflector 192 in a time sequence when actuated. In some embodiments, multiple slots with a codified size and spacing pass over reflector 192 in a manner that produces a train of reflected light pulses. (See FIG. 9).

FIG. 4 shows a cross section of a stylus with a spring loaded mechanical actuating mechanism in accordance with various embodiments of the present invention. Stylus 400 may be used as a mechanically actuated stylus in an interactive projection system. For example, stylus 400 may be used as stylus 190 (FIG. 1). Stylus 400 includes a wedge shaped reflector that includes surfaces 192A and 192B, actuating mechanism 410, and spring 404. In operation, actuating mechanism 410 translates along the body of the stylus to expose reflective surfaces 192A and 192B when actuated. The operation of spring 404 results in an occluded reflector when at rest and an exposed reflector when actuated. Some embodiments have spring 404 oriented differently such that reflector is exposed when the actuating mechanism is at rest, and occluded when actuated. Actuating mechanism 410 represents any mechanical actuating mechanism that slides or translates along the body of the stylus to expose or occlude the reflective surfaces. In some embodiments, actuating mechanism 410 is positioned on stylus 400 in such a manner that a user's finger or thumb can easily operate the mechanism to expose reflective surfaces 192A and 192B.

In some embodiments, surfaces 192A and 192B exist around the circumference of the stylus, and actuating mechanism 410 surrounds the stylus such that surfaces 192A and 192B are completely occluded when sliding mechanism 410 is at rest.

Any of the embodiments represented herein may include a wedge shaped reflector around the circumference of the stylus and/or a spring loaded actuating mechanism. For example, any of the stylus embodiments shown in FIGS. 3 and 5 may include these features.

FIG. 5 shows a cross section of a stylus with a rotating mechanical actuating mechanism in accordance with various embodiments of the present invention. Stylus 500 may be used as a mechanically actuated stylus in an interactive projection system. For example, stylus 500 may be used as stylus 190 (FIG. 1). In some embodiments, actuating mechanism 510 may be a barrel or sleeve that encompasses the end of the stylus and is able to rotate as shown. In operation, actuating mechanism 510 rotates around the tip of stylus 500 when actuated. One or more slots (not shown) in actuating mechanism 500 expose reflector 192 when actuated. In some embodiments, multiple slots with a codified size and spacing pass over reflector 192 in a manner that produces a train of reflective pulses. (See FIG. 9). In some embodiments, actuating mechanism 510 may rotate either clockwise or counterclockwise based on user input. For example, a user may press a first button for clockwise rotation or a second button for counterclockwise rotation. Different slot sequences positioned on actuating mechanism 510 may provide different codes based on rotation direction when light is reflected. Stylus 500 and actuating mechanism 500 may include buttons, springs, or any mechanism to effect the rotation of actuating mechanism 500.

Although reflector 192 is shown as a wedge shaped reflector in previous figures, this is not a limitation of the present invention. Reflector 192 may take any shape. For example, in some embodiments, reflector 192 is spherical, and in other embodiments, reflector has a multifaceted ball shape much like a geodesic dome. Various reflector shapes provide a great amount of immunity to stylus orientation with relation to the source light beam.

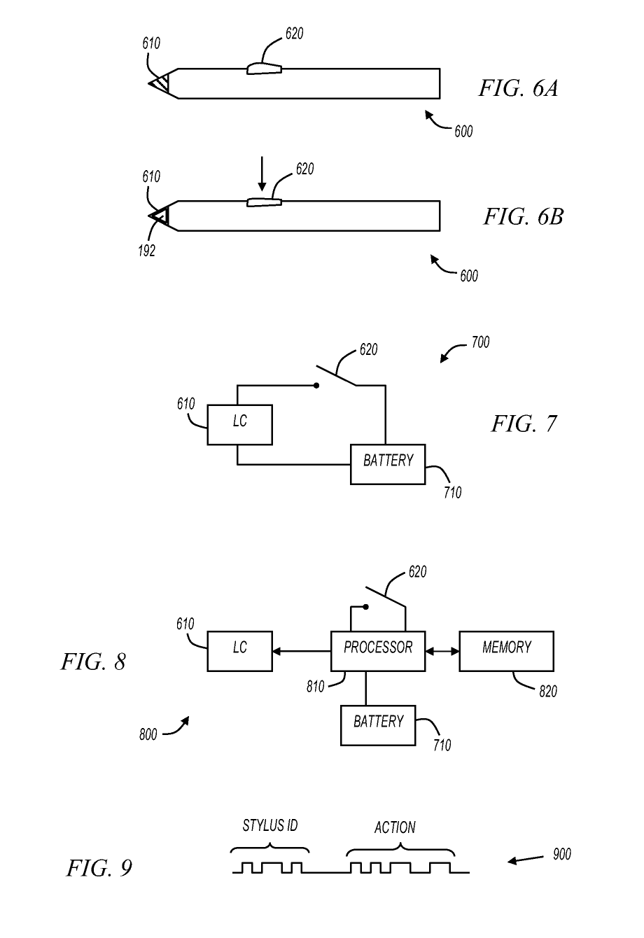

FIG. 6A shows an electrically actuated stylus with an occluded reflector in accordance with various embodiments of the present invention. Stylus 600 may be used as an electrically actuated stylus in an interactive projection system. For example, stylus 600 may be used as stylus 190 (FIG. 1). Stylus 600 includes button 620 and liquid crystal mechanism 610. When button 620 is not depressed as shown in FIG. 6A, liquid crystal 610 is opaque and any reflector is occluded. If stylus 600 is held within the field of view of a projector as shown in FIG. 1, no pixel reflection will be returned to the projection system because reflector 192 is occluded.

FIG. 6B shows the stylus of FIG. 6A with an exposed reflector in accordance with various embodiments of the present invention. FIG. 6B shows button 620 depressed, which electrically actuates the liquid crystal component 610 to become transparent, causing reflector 192 to become exposed. If stylus 600 is in the field of view of a projection system when reflector 192 is exposed as in FIG. 6B, reflections may be returned to the projection system.

FIGS. 7 and 8 show block diagrams of electrically actuated styluses in accordance with various embodiments of the present invention. Stylus 700 (FIG. 7) includes liquid crystal (LC) device 610, battery 710, and button 620 implemented as an electrical switch. Stylus 800 (FIG. 8) includes the components of stylus 700 and also includes processor 810 and memory 820.

Referring first to FIG. 7, stylus 700 electrically actuates LC 610 when button 620 is closed and the switch is closed. In some embodiments, LC 610 is opaque when not actuated, and transparent when actuated as shown in FIGS. 6A and 6B. In other embodiments, LC 610 is transparent when not actuated, and opaque when actuated. In this context, the term “actuated” refers to the application of a voltage. One skilled in the art will readily understand that LC 610 may be manufactured to be transparent or opaque when a battery voltage is applied based on polarization orientations of the various components within LC 610.

In operation, a user may hold stylus 700 in the field of view of a projector without depressing button 620, resulting in LC 610 being opaque. No reflection is provided to the interactive projection system. When button 620 is depressed, a voltage is applied to LC 610. This corresponds to actuating an electrical actuation mechanism to expose reflector 192. Reflections are then provided to the interactive projection system for as long as the electrical actuating mechanism is actuated.

Referring now to FIG. 8, processor 810 may perform any function in response to button 620 being pressed (switch closed). For example, in some embodiments, processor 810 may actuate LC 610 when button 620 is pressed, resulting in operation similar to stylus 700 (FIG. 7). In other embodiments, processor 810 may actuate LC 610 more than once for each press of button 620. For example, in some embodiments, processor 810 may actuate LC 610 multiple times using pulses of varying duration and spacing for each button press in order to encode information in the reflection. One example of encoded information is shown in FIG. 9.

Processor 810 may be any type of computing device capable of actuating LC 610 in response to a press of button 620. For example, processor 810 may be a microprocessor, a microcontroller, a digital signal processor, or the like. In some embodiments, processor 810 read instructions encoded within memory 820 and performs actions when the instructions are executed. For example, various method embodiments of the present invention are performed by processor 810 when executing instructions encoded within memory 820.

Memory 820 may be any type of memory capable of encoding instructions and/or data. For example, memory 820 may be a random access memory, a read only memory, a volatile memory, a nonvolatile memory, or the like. Memory 820 represents a storage medium that can have instructions encoded thereon, that when executed, result in a processor performing method embodiments of the present invention.

In some embodiments, processor 810 and memory 820 are replaced by a device that does not execute instructions, but still performs similar functions. For example, in some embodiments, processor 810 and memory 820 are replaced by an application specific integrated circuit (ASIC).

FIG. 9 shows a coded sequence in accordance with various embodiments of the present invention. Coded sequence 900 represents but one example of possible coded sequences. Coded sequence 900 encodes a stylus ID and an action performed by the stylus. For example, in some embodiments, multiple styluses with different stylus IDs may simultaneously be in the field of view of an interactive projection system. When each stylus encodes its ID, the interactive projection system can differentiate between the multiple styluses and their actions. Any number of pulses having any duration and spacings may be included in coded sequence 900. In some embodiments, a stylus may be assigned an ID by the interactive projection system. This may occur once during a system setup, or may occur often, such as each time a new stylus introduced to the system.

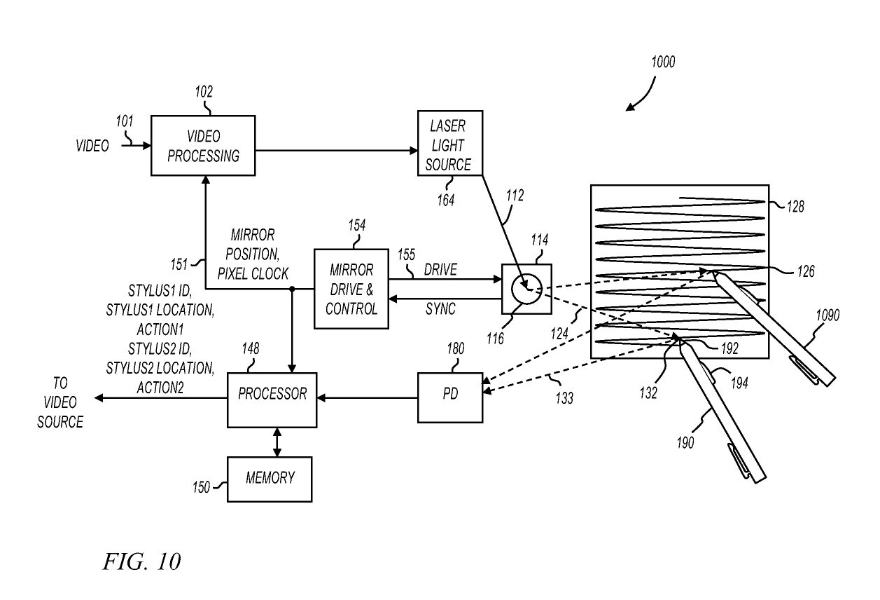

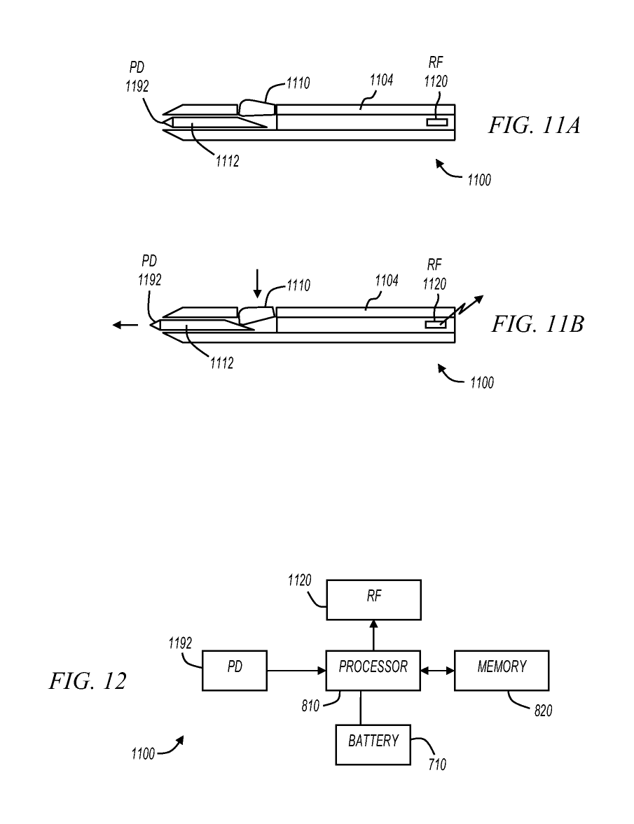

FIG. 10 shows an interactive projection system with multiple actuated styluses in accordance with various embodiments of the present invention. Interactive projection system 1000 includes a scanning laser projector and two styluses 190, 1090. Everything shown in FIG. 10 is the same as FIG. 1 with the exception of the additional stylus 1090 and the instructions encoded within memory 150.

In some embodiments, styluses 190 and 1090 are stylus embodiments capable of encoding information in the reflected light by modulating the actuating mechanism. For example, each of styluses 190 and 1090 may encode a unique stylus ID and an action. Processor 140 determines the locations styluses 190 and 1090 within the field of view based on the timing of received reflections as described above with reference to FIG. 1. Processor 140 also determines the action performed by each stylus by interpreting the encoded sequence.

FIG. 11A shows a cross section of an actuated stylus with an occluded photodetector and radio frequency transmitter in accordance with various embodiments of the present invention. Actuated stylus 1100 includes body 1104, button 1110, rod 1112, photodetector 1192 positioned at the tip of rod 1112, and radio frequency circuit 1120. The embodiment of FIG. 11A is similar to the embodiment of FIG. 2A, with the exception that reflector 192 is replaced by a photodetector, and the addition of RF circuit 1120. As shown in FIG. 11A, photodetector 1192 is occluded within the body 1104 of stylus 1100 when the actuating mechanism is not actuated. If stylus 1100 is placed within the field of view of an interactive projector, projected light will not impinge on photodetector 1192, and RF circuit 1120 does not transmit.

FIG. 11B shows a cross section of the stylus of FIG. 11A with an exposed photodetector in accordance with various embodiments of the present invention. In operation, when button 1110 is depressed, photodetector 1192 is exposed. When photodetector 1192 detects light, RF circuit 1120 is energized, and information is provided back to the interactive projection system using RF signal(s). Interactive projection system embodiments that work with Stylus 1100 include an RF receiver in place of, or in addition to, PD 180 (FIGS. 1, 10).

FIG. 12 shows a block diagram of an actuated stylus with a photodetector and radio frequency transmitter in accordance with various embodiments of the present invention. Stylus 1100 includes PD 1192, RF circuit 1120, processor 810, battery 710, and memory 820. When the actuating mechanism is mechanically actuated, PD 1192 will sense when the controlled output beam passes across the tip of stylus 1100. This information is provided to processor 810, which then commands RF circuit 1120 to transmit information. In some embodiments, RF circuit 1120 transmits a code sequence that encodes a stylus ID and action.

FIG. 13A shows an actuated stylus with an occluded photodetector and radio frequency transmitter in accordance with various embodiments of the present invention. Actuated stylus 1300 includes button 620, liquid crystal component 610, photodetector 1192, and radio frequency circuit 1120. The embodiment of FIG. 13A is similar to the embodiment of FIG. 6A, with the exception that reflector 192 is replaced by a photodetector, and the addition of RF circuit 1120. As shown in FIG. 13A, photodetector 1192 is occluded by LC 610 when the actuating mechanism is not actuated. If stylus 1300 is placed within the field of view of an interactive projector, projected light will not impinge on photodetector 1192, and RF circuit 1120 does not transmit.

FIG. 13B shows the stylus of FIG. 13A with an exposed photodetector in accordance with various embodiments of the present invention. In operation, when button 620 is depressed, the electric actuating mechanism is actuated (LC 610 is energized) and photodetector 1192 is exposed. When photodetector 1192 detects light, RF circuit 1120 is energized, and information is provided back to the interactive projection system using RF signal(s). Interactive projection system embodiments that work with Stylus 1300 include an RF receiver in place of, or in addition to, PD 180 (FIGS. 1, 10).

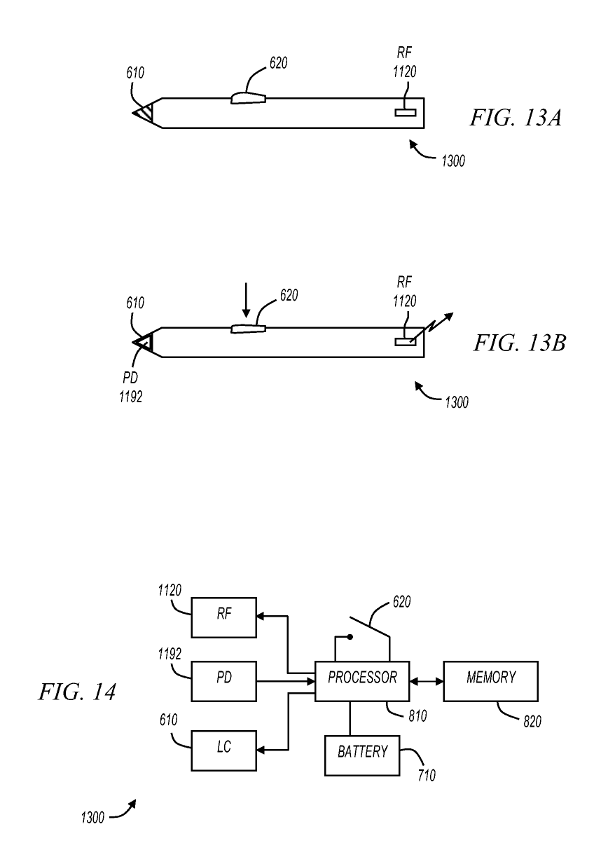

FIG. 14 shows a block diagram of an actuated stylus with a photodetector and radio frequency transmitter in accordance with various embodiments of the present invention. Stylus 1300 includes PD 1192, RF circuit 1120, LC 610, processor 810, battery 710, and memory 820. When the actuating mechanism is electrically actuated, PD 1192 will sense when the controlled output beam passes across the tip of stylus 1300. This information is provided to processor 810, which then commands RF circuit 1120 to transmit information. In some embodiments, RF circuit 1120 transmits a code sequence that encodes a stylus ID and action.

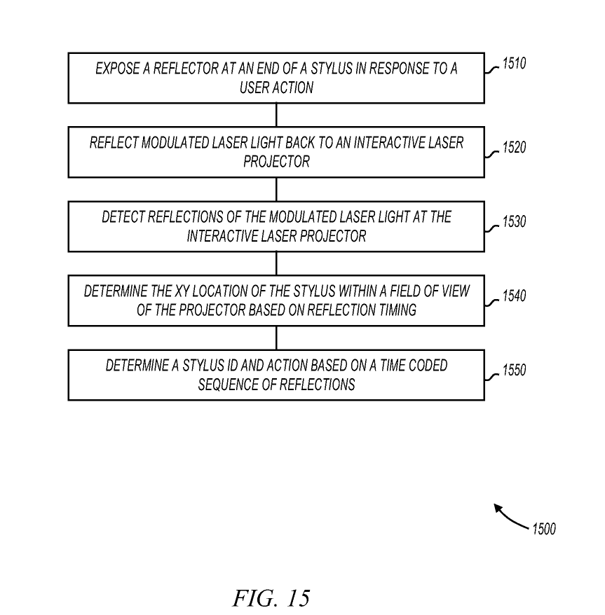

FIG. 15 shows a flow diagram of methods in accordance with various embodiments of the present invention. In some embodiments, method 1500, or portions thereof, is performed by the combination of an actuated stylus and an interactive projection apparatus, embodiments of which are shown in previous figures. In other embodiments, method 1500 is performed by a series of circuits or an electronic system. Method 1500 is not limited by the particular type of apparatus performing the method. The various actions in method 1500 may be performed in the order presented, or may be performed in a different order. Further, in some embodiments, some actions listed in FIG. 15 are omitted from method 1500. For example, some method embodiments only include actions performed by an actuated stylus, and other embodiments only include actions performed by an interactive projection apparatus.

Method 1500 is shown beginning with block 1510. As shown at 1510, a reflector is exposed at the end of a stylus in response to user action. In some embodiments, this corresponds to a mechanical actuation mechanism exposing a reflector. Examples of mechanical actuation mechanisms are shown in previous figures. In other embodiments, this corresponds to an electrical actuation mechanism exposing a reflector. Examples of electrical actuation mechanisms are shown in previous figures. The actions of 1510 may be performed by any actuated stylus.

At 1520, modulated laser light is reflected back to an interactive laser projector. This corresponds to reflector 192 reflecting modulated laser light as shown in, and described with reference to, FIGS. 1 and 10. In some embodiments, the reflector is exposed in a coded time sequence to reflect an encoded light sequence. An example coding sequence is shown in FIG. 9.

At 1530, reflections of the modulated laser light are detected at the interactive projection system. In some embodiments, the reflection is from a single pixel. For example, the reflection may emanate from a retroreflector exposed on an actuated stylus.

At 1540, the x,y location of the stylus within the projector's field of view is determined based on reflection timing. In some embodiments, this is accomplished by a processor executing instructions as shown in FIG. 1. In other embodiments, this is accomplished by a dedicated circuit that compares reflection timing with known timing of a scanning mirror that reflects the modulated laser light.

At 1550, a stylus ID and action are determined based on a time coded sequence of reflections. In some embodiments, this corresponds to a photodetector (180, FIG. 1) receiving a time coded sequence of reflections and providing signals representing the time coded sequence to a processor or dedicated circuit (processor 148, FIG. 1). The processor then decodes the time coded sequence to determine the stylus from which the reflection emanated (stylus ID), and any encoded action.

In some embodiments, the actions of method 1500 are performed for multiple styluses. For example, referring to FIG. 10, stylus 190 and stylus 1090 may both reflect the modulated laser light, but each may encode a different stylus ID and action. The interactive projection system may then determine the x,y location of each stylus and any encoded actions for each stylus.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. A stylus comprising:
a reflective element disposed at one end of the stylus; and
an actuating mechanism to conditionally expose the reflective element.

2. The stylus of claim 1 wherein the reflector comprises a retroreflector.

3. The stylus of claim 1 wherein the actuating mechanism comprises a mechanically actuated mechanism.

4. The stylus of claim 1 wherein the actuating mechanism comprises an electrically actuated mechanism.

5. The stylus of claim 1 wherein the actuating mechanism exposes the reflective element when actuated.

6. The stylus of claim 1 wherein the actuating mechanism occludes the reflective element when actuated.

7. The stylus of claim 1 wherein the actuating mechanism comprises a spring loaded mechanism.

8. The stylus of claim 1 wherein the actuating mechanism comprises a liquid crystal element.

9. The stylus of claim 1 wherein the actuating mechanism is configured to expose the reflective element more than once as a time sequence of exposures.

10. The stylus of claim 9 wherein the time sequence of exposures comprises exposures of different durations.

11. The stylus of claim 9 wherein the time sequence of exposures comprises exposures with different spacings in time.

12. An interactive projection system comprising:
a scanning laser projector that scans a modulated laser beam to paint an image;
a photodetector to detect reflections of the laser beam; and
a processing element configured to recognize a sequence of reflections as having emanated from a stylus.

13. The interactive projection system of claim 12 wherein the sequence of reflections comprises reflections with different durations.

14. The interactive projection system of claim 12 wherein the sequence of reflections comprises reflections with different time spacings.

15. The interactive projection system of claim 12 wherein the processing element is further configured to recognize a plurality of sequences of reflections as having emanated from a plurality of styluses.

16. The interactive projection system of claim 12 further comprising the stylus.

17. The interactive projection system of claim 16 wherein the stylus comprises:
a reflective element to reflect the laser beam; and
an actuating mechanism to conditionally expose the reflective element.

18. The interactive projection system of claim 17 wherein the actuating mechanism comprises a mechanically actuated mechanism.

19. The interactive projection system of claim 17 wherein the actuating mechanism comprises an electrically actuated mechanism.

20. The interactive projection system of claim 19 wherein the electrically actuated mechanism comprises a liquid crystal element.

21. A method comprising:
exposing a reflector at an end of a stylus in response to a user action, wherein the reflector is configured to reflect a scanning laser beam when exposed.

22. The method of claim 21 wherein exposing a reflector comprises mechanically actuating a mechanism that exposes the reflector.

23. The method of claim 21 wherein exposing a reflector comprises electrically actuating a mechanism that exposes the reflector.

24. The method of claim 21 wherein exposing a reflector comprises exposing the reflector in a coded time sequence.
